(19) United States
(12) Patent Application Publication
(10) Pub. No.: US 2010/0098442 A1
(43) Pub. Date: Apr. 22, 2010

(54) WASTE DEVELOPER COLLECTING UNIT AND IMAGE FORMING APPARATUS HAVING THE SAME

(75) Inventor: Bong-Hee LEE, Suwon-si (KR)

Correspondence Address: DLA PIPER LLP US, P. O. BOX 2758, RESTON, VA, 20195, US

(73) Assignee: SAMSUNG ELECTRONICS CO., LTD., Suwon-si (KR)

(21) Appl. No.: 12/561,543

(22) Filed: Sep. 17, 2009

(30) Foreign Application Priority Data
Oct. 17, 2008 (KR) 10-2008-0101888

(51) Int. Cl. G03G 21/12

(52) U.S. Cl. 399/35

(57) ABSTRACT

Disclosed is a waste developer collecting unit of an image forming apparatus that can include a casing configured to store waste developer, an auger rotatably disposed inside the casing and configured to move the waste developer around inside the casing, a detection unit configured to detect a load applied to the auger, the applied load being in corresponding relationship with an amount of waste developer stored in the casing, and a control unit configured to determine whether the amount of waste developer in the casing has reached a reference amount based on the detection result produced by the detection unit.

### CROSS-REFERENCE TO RELATED APPLICATION

This application claims priority from Korean Patent Application No. 10-2008-0101888, filed on Oct. 17, 2008 in the Korean Intellectual Property Office, the disclosure of which is incorporated herein by reference in its entirety.

### TECHNICAL FIELD

Apparatuses consistent with the present disclosure relate generally to a waste developer collecting unit and an image forming apparatus having the same that collects and stores waste developer remaining residual after a printing job, and more particularly, to a waste developer collecting unit and an image forming apparatus having the same that senses and informs of the amount of the collected waste developer.

### BACKGROUND OF RELATED ART

An image forming apparatus uses developer (e.g., toner) or ink to form a visible image on a printing medium based on an input image data. An electro-photographic type image forming apparatus can form an electrostatic latent image on an image carrying body as a pattern of electrical potential difference, and can supply developer to the electrostatic latent image to form the visible image, which can then be transferred to the printing medium.

Typically, a certain amount of developer may not be transferred to the printing medium, and thus remain residual on the image carrying body or in other components of the image forming apparatus during each printing job. Such residual amount of developer is often referred to as waste developer. The image forming apparatus can be provided with a waste developer collecting unit that collects and stores the waste developer.

The waste developer collecting unit of the image forming apparatus can store the waste developer that is collected in a casing. A user may have to replace or empty the casing when the amount of waste developer in the casing exceeds a predetermined set amount. There are currently waste developer collecting units having a configuration that allows for sensing the amount of waste developer stored in the casing.

In a conventional waste developer collecting unit, a transparent window can be formed on one side of the casing and an optical sensor can be disposed outside the casing to sense the amount of waste developer stored in the casing through the transparent window.

In such a configuration, however, it is possible for the transparent window to get contaminated by, for example, dispersing of the waste developer inside the casing. When contamination occurs, it may be difficult for the optical sensor to sense the waste developer and thus correctly determine the amount of waste developer collected in the waste developer collecting unit.

### SUMMARY OF THE DISCLOSURE

According to some aspects of the present disclosure, a waste developer collecting unit of an image forming apparatus can be provided to include a casing, an auger, a detection unit and a control unit. The casing may define a storage space for waste developer. The auger may be rotatably disposed inside the casing, and may be configured to move the waste developer stored in the casing. The detection unit may be configured to detect a behavioral characteristic of the auger associated with a load applied to the auger, the applied load being variable in correspondence with an amount of waste developer in the casing. The control unit may be configured to determine, based on the behavioral characteristic of the auger detected by the detection unit, whether the amount of waste developer in the casing is greater than or equal to a reference amount.

In one embodiment, the behavioral characteristic may comprise a rotational period of the auger. The control unit may be configured to determine whether the amount of waste developer in the casing is greater than or equal to the reference amount based on the detected rotational period.

The control unit may be configured to compare the detected rotational period of the auger to a reference rotational period.

The detection unit may comprise an interrupt unit and a sensor disposed adjacent the interrupt unit. The interrupt unit may be configured to rotate together with the auger, and may comprise a protrusion and a groove arranged alternatingly along the rotation direction of the interrupt unit. The sensor may be configured to detect a rotation of at least one of the protrusion and the groove of the interrupt unit.

In some embodiments, the control unit may be configured to determine the rotational period of the auger based on a signal pattern produced by the sensor, and to determine whether the amount of waste developer in the casing is greater than or equal to the reference amount based on the detected rotational period of the auger.

The control unit may be configured to determine whether the amount of waste developer in the casing is greater than or equal to the reference amount based on a comparison of the detected rotational period of the auger with a reference rotational period.

The interrupt unit may include a plurality of protrusions and a plurality of grooves alternatingly arranged. A first one of the plurality of protrusions may have a width wider than that of a second one of the plurality of protrusions.

Alternatively, a first one of the plurality of grooves may have a width wider than that of a second one of the plurality of grooves.

The waste developer collecting unit may further comprise a motor and a middle gear in engaged connection with a rotational shaft of the auger so as to transfer a driving force produced by the motor to the rotational shaft of the auger.

The interrupt unit may be formed on one of the rotational shaft of the auger and the middle gear unit.

The casing may include a plurality of holes through which the waste developer flows into the casing. The plurality of holes may be arranged along a first direction. The auger may include a rotational shaft extending along the first direction and a blade forming a spiral shape along the rotational shaft.

The waste developer collecting unit may further comprise a display unit. The control unit may be configured to cause the display unit to display an information relating to whether the amount of waste developer in the casing is greater than or equal to the reference amount.

According to another aspect, an image forming apparatus may be provided to include a medium supplying unit, an image forming unit, a fusing unit and a waste developer collecting unit. The medium supplying unit may be configured to supply a printing medium. The image forming unit may be configured to form an image on the printing medium supplied using a developer. The fusing unit may be configured to fuse the formed image to the printing medium. waste developer collecting unit configured to receive waste developer from the image forming unit. The waste developer collecting unit may comprise a casing, an auger, a detection unit and a control unit. The casing may define a storage space for waste developer. The auger may be rotatably disposed inside the casing, and may be configured to move the waste developer stored in the casing. The detection unit may be configured to detect a behavioral characteristic of the auger associated with a load applied to the auger, the applied load being variable in correspondence with an amount of waste developer in the casing. The control unit may be configured to determine, based on the behavioral characteristic of the auger detected by the detection unit, whether the amount of waste developer in the casing is greater than or equal to a reference amount.

The image forming apparatus may further comprise a display unit. The control unit may be configured to cause the display unit to display an information relating to whether the amount of waste developer in the casing is greater than or equal to the reference amount.

According to yet another aspect, a developer storage device usable with an image forming apparatus may be provided to include a developer storage chamber, a rotational member disposed inside the developer storage chamber, a rotation detection member arranged on a rotational shaft of the rotational member, a sensor disposed adjacent the rotation detection member and a control unit. The developer storage chamber may define a volume for accommodating developer. The rotational member may be configured to move the developer in the developer storage chamber. The rotation detection member may rotate together with the rotational member, and may exhibit thereon a distinctive detectable feature. The sensor may be configured to detect passing of the distinctive detectable feature as the rotation detection member rotates, and to output a sense signal upon such detection of the passing of the distinct detectable feature. The control unit may be configured receive the sense signal, and to determine, based the received sense signal, whether the amount of waste developer in the casing is greater than or equal to a reference amount.

The rotation detection member may have a generally cylindrical shape with one or more notches formed on a side periphery thereof. The one or more notches may be the distinct detectable feature. The controller may be configured to determine whether the amount of waste developer in the casing is greater than or equal to the reference amount based on a duration of time between two successive sense signals.

The controller may further be configured to compare the duration of time between two successive sense signals to a reference time duration.

The rotation detection member may have a plurality of distinct detectable features of different sizes. The sense signal produced by the sensor may comprise a signal pattern corresponding to detection of the plurality of distinct detectable features by the sensor. The controller may be configured to determine whether the amount of waste developer in the casing is greater than or equal to the reference amount based on the signal pattern received from the sensor.

The rotational member may comprise an auger having a blade that forms a spiral about the rotational shaft of the rotational member.

The controller may further be configured to cause a display of an information relating to whether the amount of waste developer in the casing is greater than or equal to the reference amount.

### BRIEF DESCRIPTION OF THE DRAWINGS

Various features and advantages of the present disclosure will become more apparent by the following detailed description of several embodiments thereof with reference to the attached drawings, of which:

FIG. 1 is a sectional side view illustrating a waste developer collecting unit of an image forming apparatus according to an embodiment of the present disclosure;

FIG. 2 is an enlarged view of a detection unit portion of the waste developer collecting unit in FIG. 1;

FIG. 3 is a perspective view the detection unit portion of FIG. 2;

FIG. 4 is an enlarged perspective view of an interrupt unit of the waste developer collecting unit in FIG. 3;

FIG. 5 is a timing diagram illustrating a duty ratio corresponding to the rotation period of the interrupt unit in FIG. 4; and

FIG. 6 is a schematic sectional side view of an image forming apparatus according to an embodiment of the present disclosure.

### DETAILED DESCRIPTION OF SEVERAL EMBODIMENTS

Reference will now be made in detail to several embodiment, examples of which are illustrated in the accompanying drawings, wherein like reference numerals refer to like elements throughout. While the embodiments are described with detailed construction and elements to assist in a comprehensive understanding of the various applications and advantages of the embodiments, it should be apparent however that the embodiments can be carried out without those specifically detailed particulars. Also, well-known functions or constructions will not be described in detail so as to avoid obscuring the description with unnecessary detail. It should also be noted that in the drawings, the dimensions of the features are not intended to be to true scale and may be exaggerated for the sake of allowing greater understanding. Repetitive description with respect to like elements of different embodiments may be omitted for the sake of brevity.

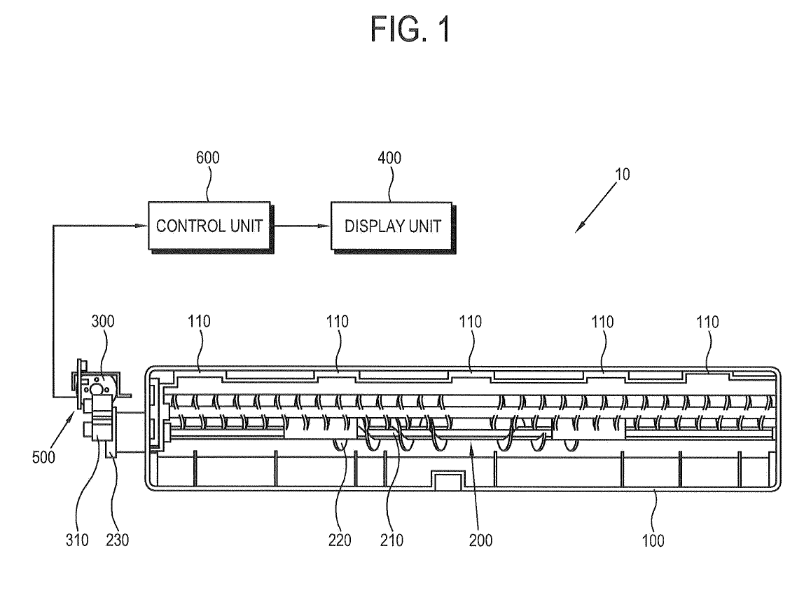

In FIG. 1, a waste developer collecting unit 10 usable in an image forming apparatus according to an embodiment of the present disclosure is illustrated. The waste developer collecting unit 10 described below can be used in connection with a color image forming apparatus that uses, for example, cyan (C), magenta (M), yellow (Y) and black (K) color developers to form a color image or with a monochromatic image forming apparatus that uses black (K) color developer to form a black and white (e.g., monochromatic) image. The number and/or type of developer used is thus not limiting.

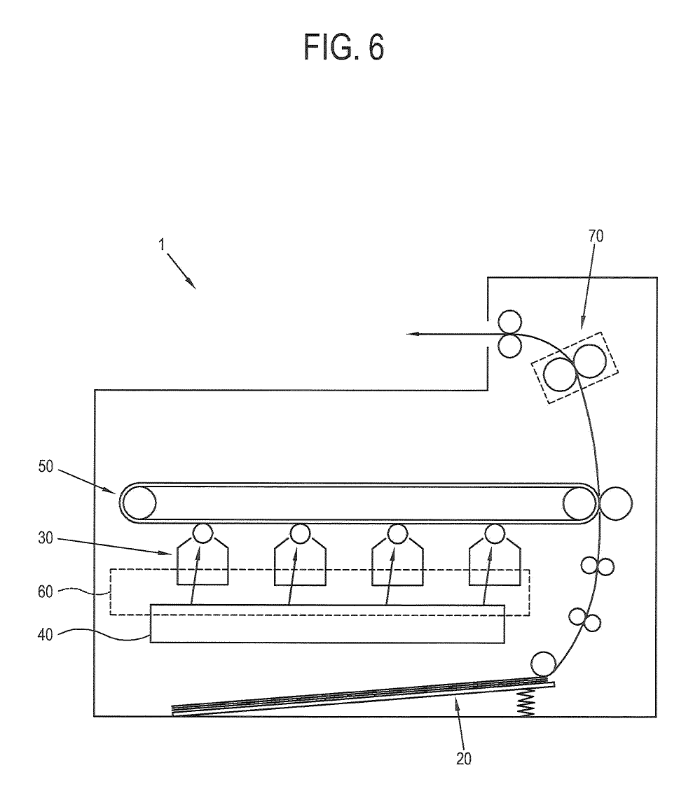

As shown in FIG. 1, the waste developer collecting unit 10 of the image forming apparatus can be configured to collect a waste developer not transferred to a printing medium from an image forming unit (e.g., shown in FIG. 6). The waste developer collecting unit 10 can include a casing 100 in which the waste developer is stored, an auger 200 configured to level the waste developer inside the casing 100, a detection unit 500 configured to detect a load (e.g., a force) applied to the auger 200 that may be proportional to the amount of the waste developer collected in the casing 100 and a control unit 600 configured to determine whether the amount of waste developer collected in the casing 100 exceeds a predetermined amount based on a detection result produced by the detection unit 500.

According to an embodiment of the waste developer collecting unit 10, the detection unit 500 can be configured to detect a period of the rotation of the auger 200. The control unit 600 can be configured to determine the amount of waste developer stored or collected inside the casing 100 based on the detected rotational period. As would be readily understood by those skilled in the art, the control unit 600 may be, e.g., a microprocessor, a microcontroller or the like, that includes a CPU to execute one or more computer instructions to implement the various control operations herein described and/or control operations relating to one or more other components of the image forming apparatus such as, for example one or more of the image forming units 30, 40 and 50 shown in FIG. 6, and, to that end, may further include a memory device, e.g., a Random Access Memory (RAM), Read-Only-Memory (ROM), a flesh memory, or the like, for storing therein the one or more computer instructions.

The waste developer collecting unit 10 can include a motor 300 configured to rotate the auger 200 and a display unit 400 configured to output or display a determination result produced by the control unit 600. Although not shown, there may be additional components or mechanisms that are used to collect the waste developer into the casing 100.

The casing 100 can be configured to have an inner portion in which waste developer collected from the image forming unit can be stored. The waste developer can be collected for storage inside the casing 100 through one or more collecting holes 110 formed through an upper portion of the casing 100. When the image forming apparatus is configured to form color images, waste developer of each of C, M, Y, and K colors can be collected through one of multiple collecting holes 110, and the casing 100 can have an elongated shape along the direction in which the developers are collected as shown in FIG. 1. The direction along which the casing 100 extends and the number and/or locations of collecting holes 110 can, preferably, but not necessarily, correspond to the location(s) of developing unit(s) (for example, as shown in FIG. 6) associated with one or more color developers.

The auger 200 can be rotatably disposed inside the casing 100. The auger 200 can be rotated by a driving force produced by the motor 300 to level (e.g., flatten) the waste developer inside the casing 100.

The auger 200 can include a rotation shaft 210 configured to extend along the inner portion of the casing 100, a blade 220 having a spiral shape along the rotation shaft 210 configured to cause a movement of the waste developer, and an auger gear unit 230 arranged at an end portion of the rotation shaft 210 and formed to protrude outwardly from the casing 100.

The rotation shaft 210 can receive the driving force produced by the motor 300 through the auger gear unit 230. According to an aspect of the present disclosure, because the rotation shaft 210 extends along a direction in which the collecting holes 110 are arranged, even when, for example, a greater amount of one color waste developer flows into one of the collecting hole 110 so as to be collected in a non-uniform manner, the waste developer in the casing 100 can advantageously be leveled uniformly.

The blade 220 can form a spiral about the rotation shaft 210. The direction of the spiral effects the direction of movement of the waste developer. For example, as shown in FIG. 1, the spiral direction of the blade 220 can be configured to be symmetrical about the collecting hole 110 located at a center portion of the casing 100. Such configuration allows the waste developer collected at opposite ends of the casing 100 to be moved toward the center portion of the casing 100. The present disclosure, however, need not be limited to this configuration, and various other blade and/or auger configuration can be employed in alternative embodiments.

The auger gear unit 230 can receive the driving force produced by the motor 300 so that the rotation shaft 210 can rotate. The auger gear unit 230 can be made integrally with the rotation shaft 210 or can be coupled to the rotation shaft 210 as a separately formed member. According to an embodiment, the auger gear unit 230 can be configured to be engaged to a middle gear unit 310 to receive the driving force from the motor 300.

The motor 300 can be configured to generate a driving force that can be transferred to the rotation shaft 210 through the middle gear unit 310 and the auger gear unit 230 so that the auger 200 can rotate. According to an embodiment, the motor 300 may desirably be configured to generate a uniform driving force so that an error in the detection of the load by the detection unit 500 may be minimized.

The middle gear unit 310 can be disposed between the motor 300, and the auger gear unit 230, and can be configured to engage with both the motor 300 and the auger gear unit 230 to transfer the driving force of the motor 300 to the rotation shaft 210.

To display the determination result produced by the control unit 600, the display unit 400 can be disposed outside the image forming apparatus in a manner that is accessible to a user. The display unit 400 can display information that shows, for example, that the amount of waste developer collected in the casing 100 is less than, the same as, or more than a predetermined amount based on a control signal generated by the control unit 600, thereby informing a user of the amount of waste developer in the casing 100.

The detection unit 500 can be configured to detect the load applied to the rotating auger 200, which may vary according to the amount of waste developer in the casing 100. That is, for example, when a small amount of waste developer is in the casing 100, the load that the waste developer applies to the auger 200 is comparably less than the load applied to the auger 200 when a larger amount of waste developer is in the casing 100. By way of example, according to an embodiment, when the driving force output from the motor 300 is uniform, the rotational speed of the auger 200 decreases as an increasing amount of waste developer is stored in the casing 100. That is, the rotation period of the auger 200 increases when the amount of waste developer in the casing 100 increases.

According to an embodiment, the detection unit 500 can periodically detect the rotation period of the auger 200, and can transmit to the control unit 600 information relating to the rotation period of the auger 200.

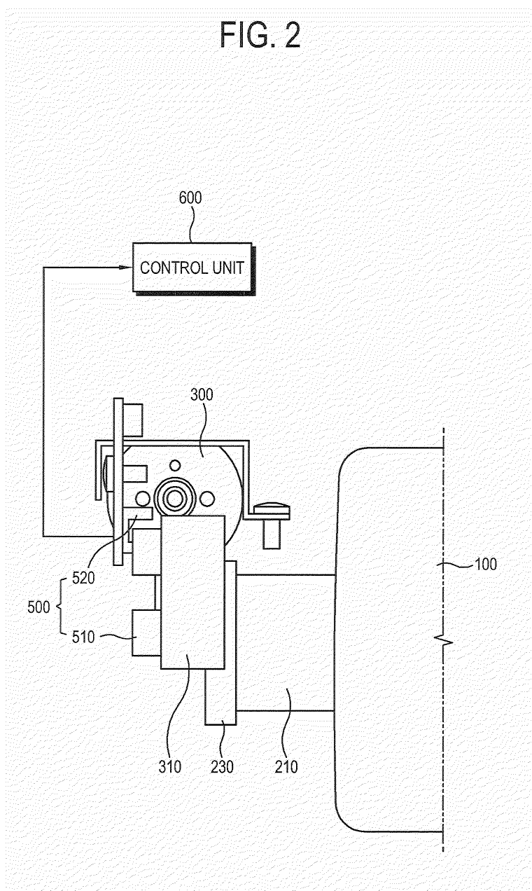

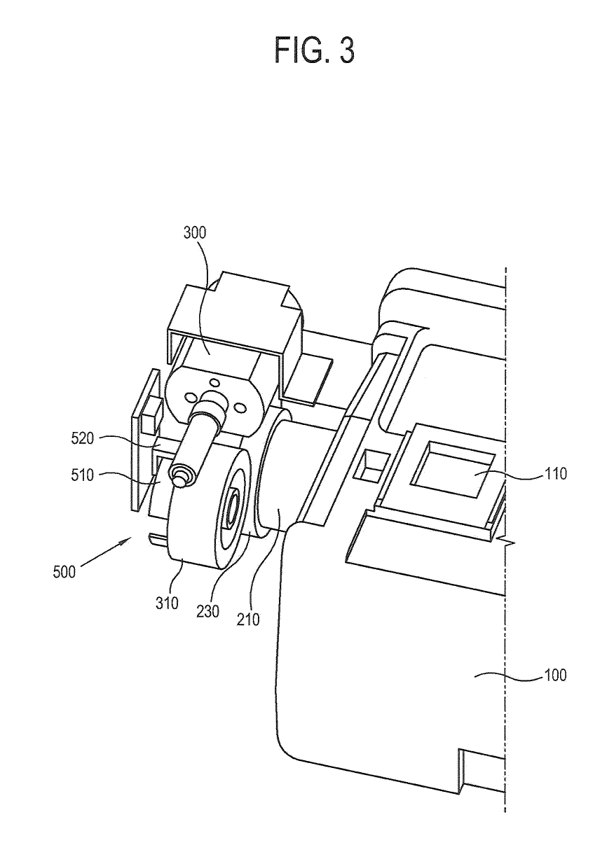

FIG. 2 is an enlarged sectional view of the detection unit 500 of the waste developer collecting unit 10 shown in FIG. 1. FIG. 3 is a perspective view of the detection unit 500 of FIG. 2.

As shown in FIGS. 2 and 3, the detection unit 500 can include an interrupt unit 510 configured to rotate by interlocking with the rotation of the auger 200 and a sensor 520 configured to sense or detect a rotation period of the interrupt unit 510.

The interrupt unit 510 can have alternating protrusions and grooves formed along the rotation direction of the auger 200 from a side of the middle gear unit 310. In one embodiment, the interrupt unit 510 can be formed in the middle gear unit 310. In other embodiments, the interrupt unit 510 can be formed on an end portion of the rotation shaft 210.

At least one pair of the protrusions and the grooves, that is, one protrusion and one groove, of the interrupt unit 510 can have different widths so that the control unit 600 can determine the rotation period of the interrupt unit 510.

The sensor 520 can include a light emitting unit (not shown) and a light receiving unit (not shown) spaced apart from each other. The sensor 520 can be configured so that a portion of the interrupt unit 510 can pass through an area or space between the light emitting unit and the light receiving unit. As the interrupt unit 510 rotates, a light emitted from the light emitting unit of the sensor 520 can pass through a groove of the interrupt unit 510 to the light receiving unit or be blocked from being received at the light receiving unit by a protrusion of the interrupt unit 510.

The sensor 520 can be configured to generate and transmit a signal to the control unit 600 having information related to the interrupt unit 510 allowing the light from the light emitting unit to pass to the light receiving unit or blocking the light from the light emitting unit from being received by the light receiving unit as the interrupt unit 510 rotates.

The control unit 600 can be configured to determine whether the waste developer collected in the casing 100 is less than, substantially equal to, or more than a predetermined amount based on the signal received from the sensor 520. The control unit 600 can determine the rotation period of the auger 200 based on the signal from the sensor 520, and can determine whether the amount of waste developer collected in the casing 100 is less than, substantially equal to, or more than the predetermined amount when the detected rotation period is less than, substantially equal to, or more than a predetermined rotation period or time, respectively.

Depending on the determination result, the control unit 600 can generate or produce a signal so as to cause the display unit 400 to display information (e.g., a message) associated with the amount of waste developer, for example, whether the waste developer collected in the casing 100 is less than, substantially equal to, or more than the predetermined amount. A user can receive this message through the display unit 400, and may decide whether to replace or empty the casing 100 base on the message.

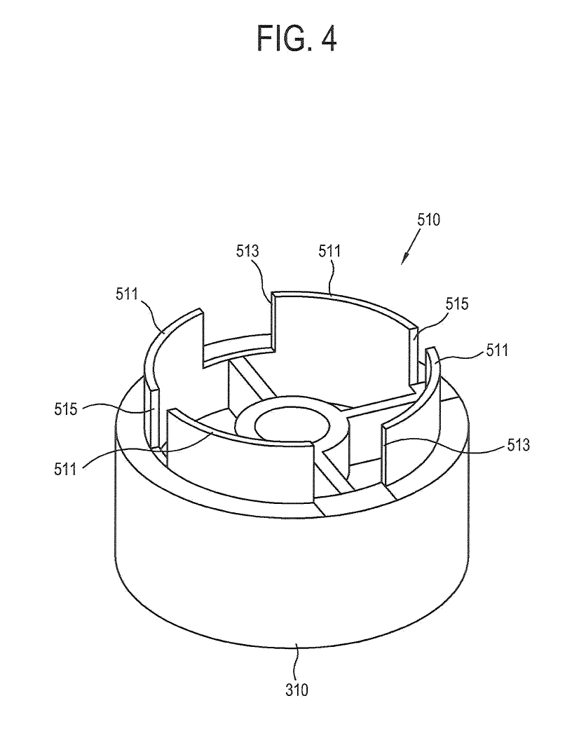

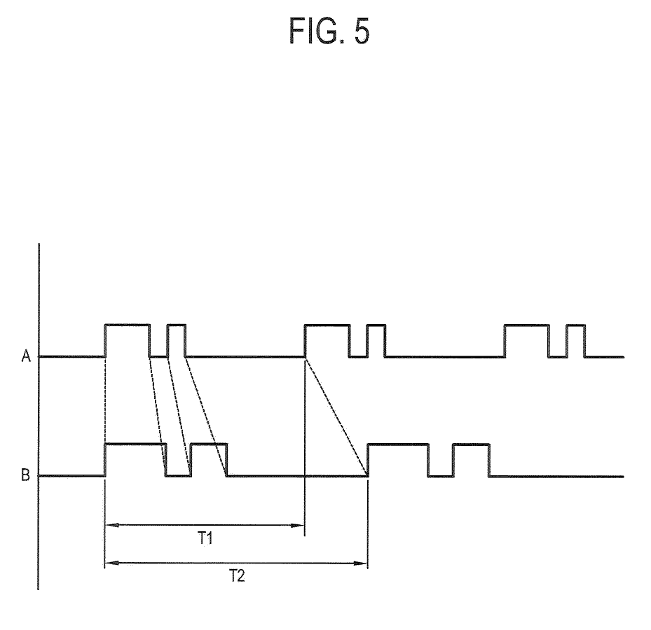

A method of determining whether the amount of waste developer collected in the casing 100 is less than, substantially equal to, or more than a predetermined amount is described by referring to FIGS. 4 and 5.

FIG. 4 is an enlarged perspective view of the interrupt unit 510 of the waste developer collecting unit 10 shown in FIG. 3.

As shown in FIG. 4, protrusions 511, first grooves 513 and second grooves 515 of the interrupt unit 510 can be disposed in an alternating manner, for example, on the middle gear unit 310 along the rotational direction thereof. According to an embodiment, as shown in FIG. 4, with the alternating configuration, a pair of first grooves 513 can be arranged to face each other while a pair of second grooves 515 facing each other.

The widths of the first grooves 513 can be wider than the widths of the second grooves 515, and accordingly, the sensor 520 may sense the first grooves 513 for a longer duration that the duration in which the second grooves 515 is sensed.

The present disclosure need not limited to the above configuration, and the protrusions and the grooves can, for example, have an opposite configuration. In another embodiment, the interrupt unit 510 can be configured to have a single protrusion or a single groove. To measure the time period, it may be preferable, but not necessary, that multiple protrusions and grooves be alternately disposed and that at least one pair, that is, one protrusion from the multiple protrusions and one groove from the multiple grooves, have different widths.

FIG. 5 is a diagram illustrative of the duty ratio of a signal sensed by the sensor 520 according to the rotation of the interrupt unit 510 shown in FIG. 4.

In FIG. 5, each of the upper graph A and the lower graph B represent rotation periods of the interrupt unit 510 during a certain time interval. As shown by the graphs A and B, the portions of the graphs associated with the first grooves 513 and with the second grooves 515 can be periodical and can have different time widths associated with them.

A comparison of graph A to graph B shows that the amount of waste developer collected in the casing 100 in graph B is larger than the amount in graph A. Such a result can be obtained from the comparison because a larger load applied to the auger 200 by a larger amount of waste developer collected reduces the rotation speed of the auger 200. That is, the rotation speed of the auger 200 can be inversely proportional to the amount of waste developer collected. Graph B shows a longer rotation period than the rotation period of graph A, thus graph B has associated with it a larger amount of waste developer collected than the amount associated with graph A.

The control unit 600 can produce the information associated with the graphs shown in FIG. 5 based on the detecting signal from the detection unit 500, and detect a predetermined time period. For example, in the embodiment shown in FIG. 5, the time period being detected can be the time period between the first grooves 513 facing each other. Other embodiments, however, need not be so limited.

A time period (Tr) as a reference period associated with a predetermined amount of waste developer being collected in the casing 100 may have been previously determined. The control unit 600 can compare the detected time period (e.g., time periods shown in FIG. 5) to Tr.

For graph A in FIG. 5, when a detected time period T1 is compared to Tr resulting in the determination that T1<Tr, the control unit 600 can determine that the amount of waste developer collected in the casing 100 is less than the predetermined amount.

When a detected time period T2 is compared to Tr with the result T2>Tr, the control unit 600 can determine that the amount of waste developer collected in the casing 100 is substantially equal to or more than the predetermined amount. Accordingly, the control unit 600 can generate a signal to display the result in the display unit 400, thereby informing a user that the amount of waste developer collected is substantially equal to or more than the predetermined amount.

According to an embodiment, the increase in the load with respect to the auger 200 based on the increase in the amount of waste developer collected can be determined quantitatively, thereby determining whether the amount of waste developer collected is substantially equal to or more than a predetermined value or whether the amount of waste developer collected is less than the predetermined amount. According to an embodiment, the control unit 600 may cause the display unit 400 to display the actual amount of waste developer as determined or a qualitative message that merely provides an indication that the amount has reached a threshold.

FIG. 6 is a schematic sectional side view of an image forming apparatus 1 according to an embodiment of the present disclosure.

As shown in FIG. 6, the image forming apparatus 1 can include a medium supplying unit 20 configured to accommodate and to supply printing media, image forming units 30, 40 and 50 configured to form a visible image using developer and to transfer the visible image to the printing medium supplied from the medium supplying unit 20, a waste developer collecting unit 60 configured to collect waste developer from the image forming units 30, 40 and 50, and a fusing unit 70 configured to fuse the transferred visible image to the printing medium.

The image forming units 30, 40 and 50 can include developing unit(s) 30 respectively corresponding to each of the developers for C, M, Y and K colors, a light scanning unit 40 configured to scan light to each developing unit 30 to form electrostatic latent images and an intermediate transfer belt 50 configured to receive the visible images formed by the developers of each color in an overlapping manner, and to transfer the overlapped visible images to the printing medium. This configuration, however, is just an example, and the present disclosure need not be limited thereto.

The waste developer collecting unit 60 can be configured to collect waste developer from the developing unit(s) 30 of each color and/or from the intermediate transfer belt 50. The waste developer collecting unit 60 can have substantially the same configuration as the waste developer collecting unit 10 according to several embodiments described above.

According to some aspects of the present disclosure, the load of the auger can be detected, and the amount of waste developer stored can be determined by the detected load, thereby correctly determining the need for the replacement or cleaning of the casing that stores the waste developer regardless of whether there is contamination by, for example, waste developer or dirt.

According to some aspects of the present disclosure, the amount of waste developer stored can be determined based on the rotational period of the auger, thereby the accuracy in the determination of the amount of waste developer stored in the casing may be improved.

According to several embodiments, the amount of waste developer stored can be determined with a configuration that includes an interrupt unit and a sensor that are used to determine the rotational period.

According to an aspect of the present disclosure, the determination of the amount of waste developer collected can be based on the rotational period of the auger itself rather than upon the rotation of the driving motor, thereby enabling improved accuracy of the determination. For example, a disagreement between the rotation of the motor and the rotation of the auger can occur due to the abrasion or slippage in the gears between the motor and the auger.

While the disclosure has been particularly shown and described with reference to several embodiments thereof with particular details, it will be apparent to one of ordinary skill in the art that various changes may be made to these embodiments without departing from the principles and spirit of the invention, the scope of which is defined in the following claims and their equivalents.

What is claimed is:

1. A waste developer collecting unit of an image forming apparatus, comprising:
a casing defining a storage space for waste developer;
an auger rotatably disposed inside the casing and configured to move the waste developer stored in the casing;
a detection unit configured to detect a behavioral characteristic of the auger associated with a load applied to the auger, the applied load being variable in correspondence with an amount of waste developer in the casing; and
a control unit configured to determine, based on the behavioral characteristic of the auger detected by the detection unit, whether the amount of waste developer in the casing is greater than or equal to a reference amount.

2. The waste developer collecting unit according to claim 1, wherein the behavioral characteristic comprises a rotational period of the auger, and
wherein the control unit is configured to determine whether the amount of waste developer in the casing is greater than or equal to the reference amount based on the detected rotational period.

3. The waste developer collecting unit according to claim 2, wherein the control unit is configured to compare the detected rotational period of the auger to a reference rotational period.

4. The waste developer collecting unit according to claim 1, wherein the detection unit comprises:
an interrupt unit configured to rotate together with the auger, the interrupt unit comprising a protrusion and a groove arranged alternatingly along a rotation direction thereof; and
a sensor disposed adjacent the interrupt unit and configured to detect a rotation of at least one of the protrusion and the groove of the interrupt unit.

5. The waste developer collecting unit according to claim 4, wherein the control unit is configured to determine a rotational period of the auger based on a signal pattern produced by the sensor, the control unit being configured to determine whether the amount of waste developer in the casing is greater than or equal to the reference amount based on the detected rotational period of the auger.

6. The waste developer collecting unit according to claim 5, wherein the control unit is configured to determine whether the amount of waste developer in the casing is greater than or equal to the reference amount based on a comparison of the detected rotational period of the auger with a reference rotational period.

7. The waste developer collecting unit according to claim 4, wherein the interrupt unit includes a plurality of protrusions and a plurality of grooves alternatingly arranged, a first one of the plurality of protrusions having a width wider than that of a second one of the plurality of protrusions.

8. The waste developer collecting unit according to claim 4, wherein the interrupt unit includes a plurality of protrusions and a plurality of grooves alternatingly arranged, a first one of the plurality of grooves having a width wider than that of a second one of the plurality of grooves.

9. The waste developer collecting unit according to claim 4, further comprising:
a motor; and
a middle gear in engaged connection with a rotational shaft of the auger so as to transfer a driving force produced by the motor to the rotational shaft of the auger.

10. The waste developer collecting unit according to claim 8, wherein the interrupt unit is formed on one of the rotational shaft of the auger and the middle gear unit.

11. The waste developer collecting unit according to claim 1, wherein the casing includes a plurality of holes through which the waste developer flows into the casing, the plurality of holes being arranged along a first direction, and
wherein the auger includes a rotational shaft extending along the first direction and a blade forming a spiral shape along the rotational shaft.

12. The waste developer collecting unit according to claim 1, further comprising:
a display unit,
wherein the control unit is configured to cause the display unit to display an information relating to whether the amount of waste developer in the casing is greater than or equal to the reference amount.

13. An image forming apparatus, comprising:
a medium supplying unit configured to supply a printing medium;
an image forming unit configured to form an image on the printing medium supplied using a developer;
a fusing unit configured to fuse the formed image to the printing medium; and
a waste developer collecting unit configured to receive waste developer from the image forming unit, the waste developer collecting unit comprising:
a casing defining a storage space for waste developer;
an auger rotatably disposed inside the casing and configured to move the waste developer stored in the casing;
a detection unit configured to detect a behavioral characteristic of the auger associated with a load applied to the auger, the applied load being variable in correspondence with an amount of waste developer collected in the casing; and
a control unit configured to determine, based on the behavioral characteristic of the auger detected by the detection unit, whether the amount of waste developer in the casing is greater than or equal to a reference amount.

14. The image forming apparatus according to claim 13, further comprising:
a display unit,
wherein the control unit is configured to cause the display unit to display an information relating to whether the amount of waste developer in the casing is greater than or equal to the reference amount.

15. A developer storage device usable with an image forming apparatus, comprising:
a developer storage chamber defining a volume for accommodating developer;
a rotational member disposed inside the developer storage chamber and configured to move the developer in the developer storage chamber;
a rotation detection member arranged on a rotational shaft of the rotational member so as to rotate together with the rotational member, the rotation detection member exhibiting thereon a distinctive detectable feature;
a sensor disposed adjacent the rotation detection member, the sensor being configured to detect passing of the distinctive detectable feature as the rotation detection member rotates, and to output a sense signal upon such detection of the passing of the distinct detectable feature; and
a control unit configured receive the sense signal, and to determine, based the received sense signal, whether the amount of waste developer in the casing is greater than or equal to a reference amount.

16. The developer storage device of claim 15, wherein rotation detection member has a generally cylindrical shape with one or more notches formed on a side periphery thereof, the one or more notches being the distinct detectable feature, and
wherein the controller is configured to determine whether the amount of waste developer in the casing is greater than or equal to the reference amount based on a duration of time between two successive sense signals.

17. The developer storage device of claim 16, wherein the controller is further configured to compare the duration of time between two successive sense signals to a reference time duration.

18. The device of claim 15, wherein the rotation detection member has a plurality of distinct detectable features of different sizes,
wherein the sense signal produced by the sensor comprises a signal pattern corresponding to detection of the plurality of distinct detectable features by the sensor, and
wherein the controller is configured to determine whether the amount of waste developer in the casing is greater than or equal to the reference amount based on the signal pattern received from the sensor.

19. The device of claim 15, wherein the rotational member comprises an auger having a blade that forms a spiral about the rotational shaft of the rotational member.

20. The device of claim 15, wherein the controller is further configured to cause a display of an information relating to whether the amount of waste developer in the casing is greater than or equal to the reference amount.
